(19) United States
(12) Patent Application Publication
(10) Pub. No.: US 2017/0271050 A1
(43) Pub. Date: Sep. 21, 2017

(54) Multi-Size Sheath-Jacket Applicator

(71) Applicants: April Blanton, Washington Court House, OH (US); Helga Malone, Washington Court House, OH (US); Connie Ingram, Washington Court House, OH (US)

(72) Inventors: April Blanton, Washington Court House, OH (US); Helga Malone, Washington Court House, OH (US); Connie Ingram, Washington Court House, OH (US)

(21) Appl. No.: 15/076,438

(22) Filed: Mar. 21, 2016

(51) Int. Cl. H01B 13/22; H02G 1/08

(52) U.S. Cl. CPC H01B 13/22; H02G 1/085

(57) ABSTRACT

A tool and method for installing one or more wires or strand like material into a soft, flexible, longitudinally split sheath, wherein the tool is capable of handling multiple sizes of sheathing and multiple sizes of wires. The tool includes two openings of different sizes and shapes to receive both the sheath and the desired strand like material to be enclosed within. The tool uses the method of inserting both materials into their respective openings and pulling both materials simultaneously, while holding the tool steady, resulting in the installation of the outer sheath over the strand like material.

### BACKGROUND

This invention was created to be able to easily and quickly insert coaxial, optical and other wires into a flexible, elastic but preformed protective sheath/tube that is split lengthwise. The flexible tube proved to be a challenge since it was elastic in composition and did not have a rigid form which did not promote the sliding of wires through the sheath, but rather the sheath had to be installed around the material for which the protection was needed. The prior art using fingertips creates a level of difficulty of inserting said wire into a flexible tube/sheath or protective jacket.

As we rely more on our media delivery devices, it is more and more important that we protect the electrical, communications lines, traditional and optical that deliver this media and communications to our homes. This invention is a hand tool that will help with the installation of the protective sheath described above.

As we searched for prior art, we found several other similar patents, but none would work in the way that our invention works to encompass the sheath or protective jacket around the material. We found the following patents.

U.S. Pat. No. 5,265,326 Wire insertion tool from Nov. 30, 1993. Wire insertion hand tool.

U.S. Pat. No. 6,749,179 from Jun. 15, 2004. Device for placing wiring into split loom tubing.

U.S. Pat. No. 7,137,181 from Nov. 21, 2006 Flexible Cable Sleeve Apparatus

U.S. Pat. No. 8,336,858 from Dec. 25, 2012 Protective Tube Auxiliary Tool.

Ours is a tool that uses a technique to quickly insert a split sheath/tube over a coaxial or other wire. Where other devices will aid in sliding the wires through a conduit split lengthwise, this tool moves both materials through the tool at the same time which combines the two materials, one inside the other as the two materials exit the tool.

### SUMMARY

To achieve this, we invented a tool of simple design to be used in conjunction with a simple process that will allow minimal effort to pull the tool, with the wire and the sheath inserted into openings of specific measurements to hold open the sheath and allow for simple installation of the sheath around the wire.

The tool is fabricated of flat polymer material, lightweight and non-conductive. It is made with a section for gripping and holding the tool. There are two pairs of openings in the tool, one for the jacket to slide through and one for the wire to be covered to slide through.

The main objective of this tool is to find a way to alleviate the use of fingertips to install the sheath, and reduce the inflammation caused to the fingertips.

The second objective was to find a way to install the sheath more quickly to save time.

To the accomplishment of the above and related objects, this invention may be embodied in the form illustrated in the included drawings, attention being called to the fact, however, that the drawings are illustrative only, and that changes may be made in the specific construction illustrated and described within the scope of the appended claims.

In addition, the size of the openings and the relationship of the two will vary depending on the size of the wire and sheath being utilized. As in the case of the common screwdriver, the tool will come in various sizes to accommodate the material being used at that time.

### BRIEF DESCRIPTION OF DRAWINGS

FIG. 1 illustrates how the tool is manufactured in its preferred composition.

Numbers 2 and 4 indicate holes that should be sized appropriately for the size of wire you are using. In this case ⅜ inch hole to accommodate RG6 coaxial wire.

Number 6 and 8 indicates the opening for the flexible sheath to be installed over the wire. In this example, number 6 is 1 inch long and 3/16 inch high.

FIG. 2 shows the tool along with wire and the sheath in its state just before being put through the tool. Number 12 which is the flexible, elastic sheath flattened out and threaded into number 6 the flat opening in the tool.

Then the tool containing the threaded piece of flexible sheath is then slid onto the piece of wire number 10 to the point where the sheath is desired. The wire goes into the opening marked number 2. Once you get both wires through, the sheath will close down and around the wire as it reverts back to its normal closed state. At this point the user can hold both the wire and the sheath and pull them through the tool and the sheath will continue to close down and around the wire.

In FIG. 3, you can see where the sheath then closes over the wire, where one can then grasp both the sheath and the wire holding it securely at point number 14 with one hand. Using the other hand, progressively slide the tool away from point number 14 and the tool will simultaneously open the sheath number 12 and encompass the wire threaded below number 10.

Number 16 illustrates that to enable this tool to work, one hand must hold the combined material on the output of the tool and pull the opposite direction to pull both products through the holes to enable the tool to combine the two materials. FIG. 3 is simply a graphic of the tool in its current composition.

### DETAILED DESCRIPTION

With the tool and using this technology, the sheath is held open, while simultaneously inserting the coaxial wire into the sheath using a simple pulling motion.

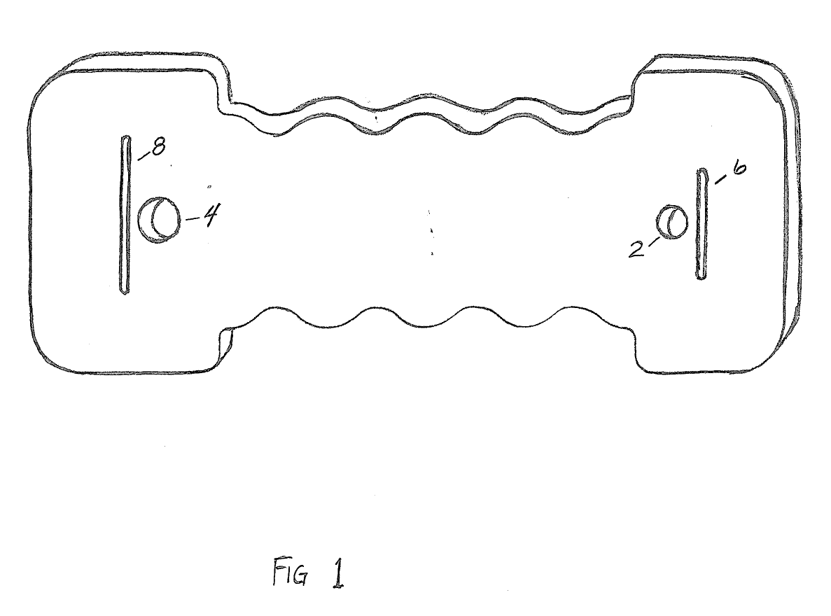

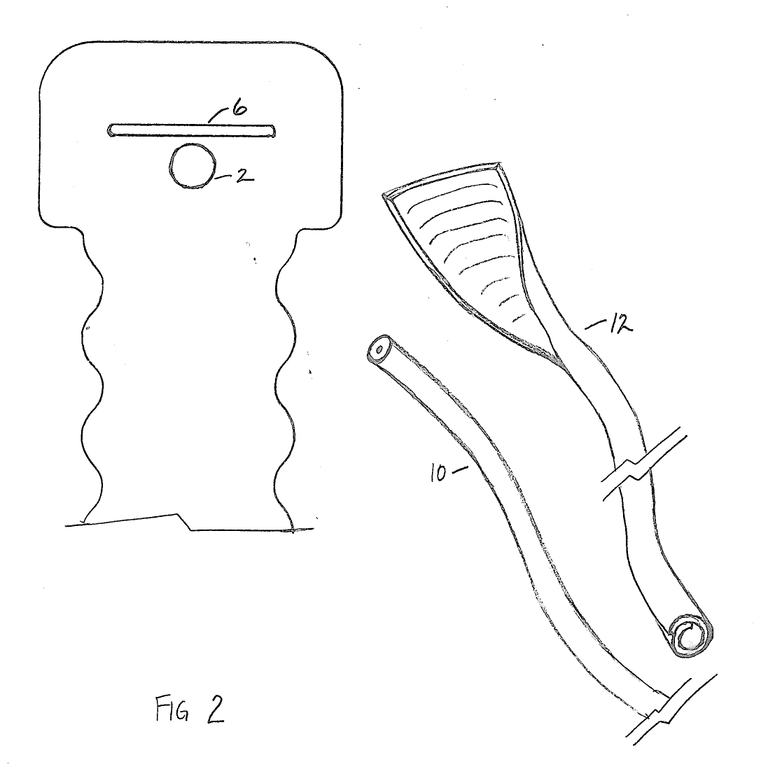

The tool works well made of polyurethane with the details described above. The tool is light, easy to handle and slides easily over both the wire and the flexible sheath. The current ⅜ inch thickness is adequate for the tool to retain enough strength to stay rigid and not bend or break during use. See FIG. 1.

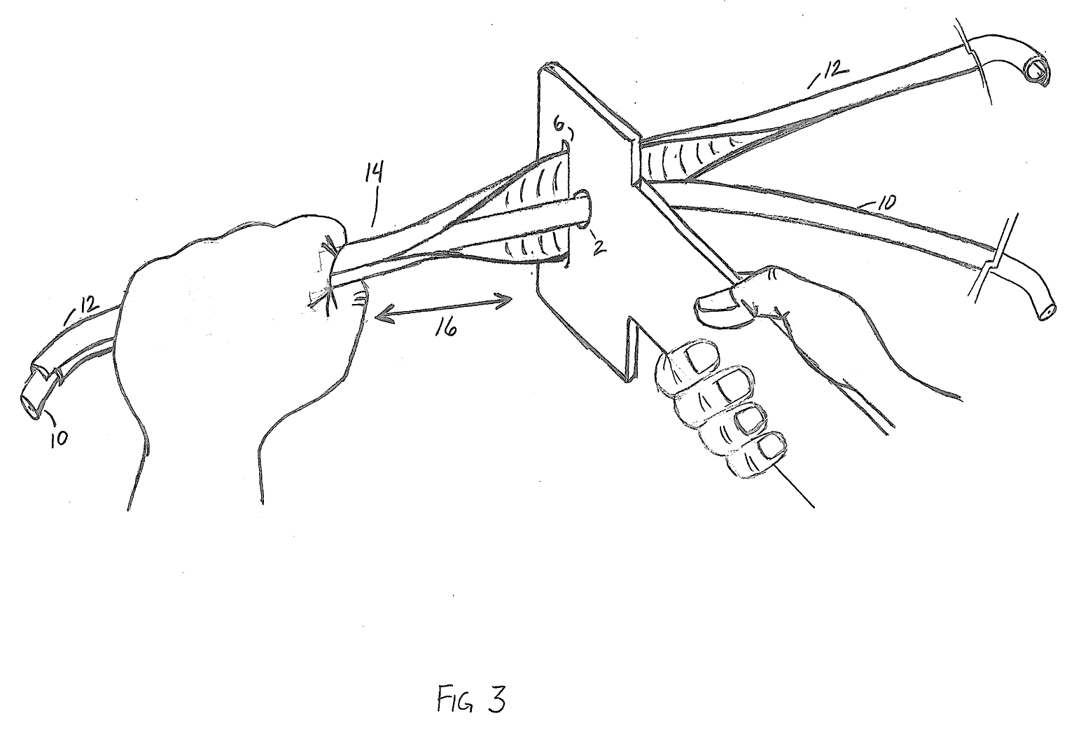

The key to the technology is the proximity of the pair of holes to be able to open the sheath and insert the wire in a single motion. The hole for the sheath must be the size of the sheath in its open and flattened state. See FIG. 2.

Once you thread the sheath through the opening and over the wire, grasp the sheath covered wire securely with one hand. Using the other hand, holding the tool about ninety degrees from the sheath and wire combined, slide the tool down both the wire and the sheath until the desired coverage is complete as illustrated in FIG. 3.

The device in its current state consists of a plastic composition, being easy to hold and easy to store. It is very portable and can be used in any location. It can be used by either left or right hand. It allows the easy installation of a flexible sheath over a wire by having the openings sized proportionately and in proximity to allow a smooth pulling action over both the wire and the sheath. It allows a much quicker, and easier installation than doing it by hand and also helps alleviate pain to the installer's fingertips.

We claim:

1. A hand tool with a design that utilizes a technique to install a flexible, elastic protective sheath or jacket, split lengthwise around multiple sizes and types of wires for protection against damage, whereas that tool is comprised of two appropriately sized holes on each end of the tool to accommodate two sizes of wires, with a handle in the middle between the two ends and can be used equally well with either hand.

2. Where the tool in claim number 1 is made of polyurethane material formed in injection mold to be portable, lightweight and non-conductive and can be used in any weather.

3. Whereas there are a pair of holes in each end in claim #1 and the pair of holes, one circular and one oblong or linear, are made as close to each other as possible, without weakening the strength of the tool.

4. Where in claim number 3 the round hole is designed for the material which is desired to be covered with the flexible, elastic protective sheath, and is made slightly larger than that material to allow for user to easily slide the tool in claim number 1 along the material.

5. Where in claim number 3 the oblong, linear hole is for the sheath to be flattened by hand and pushed through
the hole where as it exits the tool, it relaxes back to its natural form and encompasses the wires in the adjacent circular hole.

6. Where the sheath used in claim 5 is a flexible, rubberized material without rigid lengthwise form on its own; however it is normally closed circular cross section, forming a tubular design with a longitudinal slot the entire length with open ends.

7. Where in claim 5 once exited from the tool, both the material and the sheath are combined as desired by grasping and using a pulling motion with both materials in hand.

8. Where in claim 7 holding the combined material in one hand, the tool in the other hand at about ninety degrees perpendicular from the combined wire and sheath, and pull opposite directions with each hand to continue the process of progressively sliding the tool along the sheath encompassing the desired material to be covered. As the tool slides along each segment of sheath, the tool holds the sheath open long enough to insert the wire into the sheath and it recloses covering the wire as desired.
